(19) United States
(12) Patent Application Publication
(10) Pub. No.: US 2007/0125918 A1
(43) Pub. Date: Jun. 7, 2007

(54) Benchtop product securing device

(75) Inventors: Jurgen Krause, Tampa, FL (US); Robert A. Schultz, Maderia Beach, FL (US); Winston S. Webb, Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/295,076

(22) Filed: Dec. 6, 2005

(51) Int. Cl. F16M 11/20

(52) U.S. Cl. 248/188.1

(57) ABSTRACT

A benchtop securing device for securing objects to a table is provided. The benchtop securing device comprises a mounting plate having a table engaging surface adapted to abut a surface of a table, the mounting plate further having an object attaching surface adapted to mount an object thereon, and a sloped member having a sloping surface, the sloped member further being coupled to the mounting plate such that the table can be received between the mounting plate and the sloping surface of the sloped member. The benchtop securing device further comprises a sliding block having a sliding surface that has a slope that substantially matches the slope of the sloping surface of the sloped member, wherein when the sliding surface of the sliding block engages the sloping surface of the sloped member the benchtop securing device becomes securely attached to the table.

### TECHNICAL FIELD

The present invention generally relates to securing devices and, in particular, to a benchtop product securing device.

### BACKGROUND

It is a common occurrence in a lab environment for a test object to be dragged or knocked off a table to the floor. The resultant damage to the object can often cost large amounts of money to repair and/or result in large setbacks in time. Objects being tested can fall off a table for many different reasons. For example, a person may bump into the object or trip on a cable connected to the object, and, in some cases, the weight of the cable itself may pull the object off the table. However, despite the common occurrence of this unfortunate experience, no satisfactory solution is available to help prevent objects from falling off the lab table.

Certain available devices may function for a limited class of objects. For example, clamps and vices may help support solid objects. However, many objects can not support the force required to secure it by a clamp or vice. For example, many electronic devices would cease to function properly due to the damage caused by the pressure of the vice itself. Similarly, drilling screw holes, making slots and buckets in the table itself may function to a certain degree. However, since many different objects of varying sizes, shapes, strength, etc. will be required, this is not a viable solution.

Therefore, for the reasons stated above, and for other reasons stated below which will become apparent to those skilled in the art upon reading and understanding the present specification, there is a need in the art for a securing device which secures objects of varying size, shape, strength, etc. to a table.

### SUMMARY

The above-mentioned problems and other problems are resolved by the present invention and will be understood by reading and studying the following specification.

In one embodiment, a benchtop securing device for securing objects to a table is provided. The benchtop securing device comprises a mounting plate having a table engaging surface adapted to abut a surface of a table, the mounting plate further having an object attaching surface adapted to mount an object thereon, and a sloped member having a sloping surface, the sloped member further being coupled to the mounting plate such that the table can be received between the mounting plate and the sloping surface of the sloped member. The benchtop securing device further comprises a sliding block having a sliding surface that has a slope that substantially matches the slope of the sloping surface of the sloped member, wherein when the sliding surface of the sliding block engages the sloping surface of the sloped member the benchtop securing device becomes securely attached to the table.

In another embodiment, a method for securing an object to a table using a benchtop securing device is provided. The method comprises positioning a benchtop securing device about a table such that the table is received between a mounting plate and a sloped member of the benchtop securing device leaving a gap between a sloping surface of the sloped member and a surface of the table, and inserting a sliding block having a sliding surface with a slope that substantially matches the slope of the sloping surface of the sloped member between the sloping surface of the sloped member and the surface of the table such that the sliding surface of the sliding block engages the sloping surface of the sloped member, wherein when the sliding surface of the sliding block engages the sloping surface of the sloped member the benchtop securing device becomes securely attached to the table. The method further comprises coupling an object to the mounting plate of the benchtop securing device.

### DRAWINGS

The present invention can be more easily understood and further advantages and uses thereof more readily apparent, when considered in view of the description of the preferred embodiments and the following figures in which:

FIG. 1 is a side view of a benchtop securing device according to one embodiment of the present invention.

FIG. 2 is an isometric view of a benchtop securing device according to one embodiment of the present invention.

FIG. 3 is an isometric view of exemplary mounting shapes according to embodiments of the present invention.

FIG. 4 is an isometric view of exemplary configurations of a mounting plate according to embodiments of the present invention.

FIG. 5 is a flowchart showing a method for securing an object to a table using a benchtop securing device according to one embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should be understood that the exemplary method illustrated may include additional or fewer steps or may be performed in the context of a larger processing scheme. Furthermore, the method presented in the drawing figures or the specification is not to be construed as limiting the order in which the individual steps may be performed. The following detailed description is, therefore, not to be taken in a limiting sense.

Embodiments of the present invention are adaptable to secure objects, such as devices under test, of varying size, shape, structural strength, etc. to a table through use of a benchtop securing device. Embodiments of the benchtop securing device are simple to configure, require few parts, and substantially reduce the risk of an object being knocked or pulled off a table. Moreover, by securing objects using embodiments of the present invention, time and money can be saved.

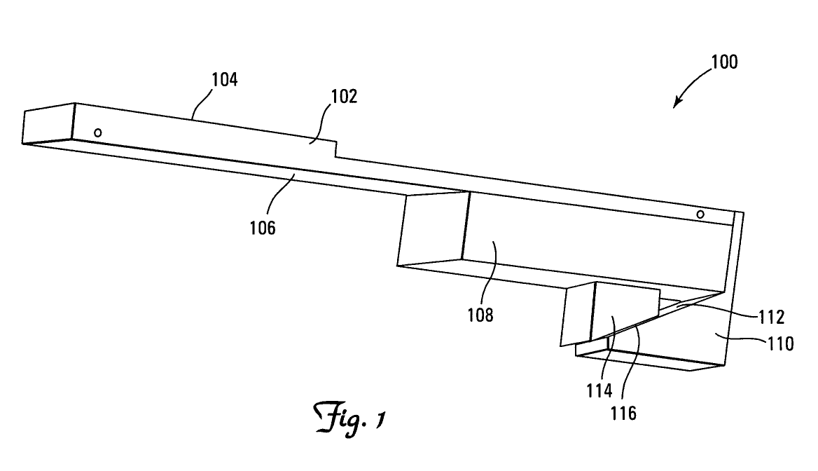

FIG. 1 is a side view of benchtop securing device 100 according to one embodiment of the present invention. Benchtop securing device 100 includes mounting plate 102, sloped member 110, and sliding block 114. In order to provide a clearer view of mounting plate 102, table 108 is shortened in FIG. 1. However, it will be understood by one of skill in the art that benchtop device 100 is adaptable to function with any length, width and thickness of table 108. Mounting plate 102 is comprised of attaching surface 104 and table engaging surface 106. Table engaging surface engages a surface of table 108. An object to be secured with benchtop device 100 is coupled to attaching surface 104.

Sloped member 110 is coupled to mounting plate 102 such that table 108 is received between mounting plate 102 and sloped member 110 and such that a gap is left between sloping surface 112 of sloped member 110 and a surface of table 108. Sliding block 114 has sliding surface 116 which has a slope that substantially matches the slope of the sloping surface of the sloped member. Because the slopes substantially match, sliding block 114 fits between sloped member 110 and table 108. Insertion of sliding block 114 between sloped member 110 and table 108 causes sliding surface 116 to engage sloping surface 112 which secures benchtop securing device 100 to table 108. Therefore, by securing an object to attaching surface 104 of mounting plate 102, benchtop securing device 100 helps prevent the object from falling off table 108.

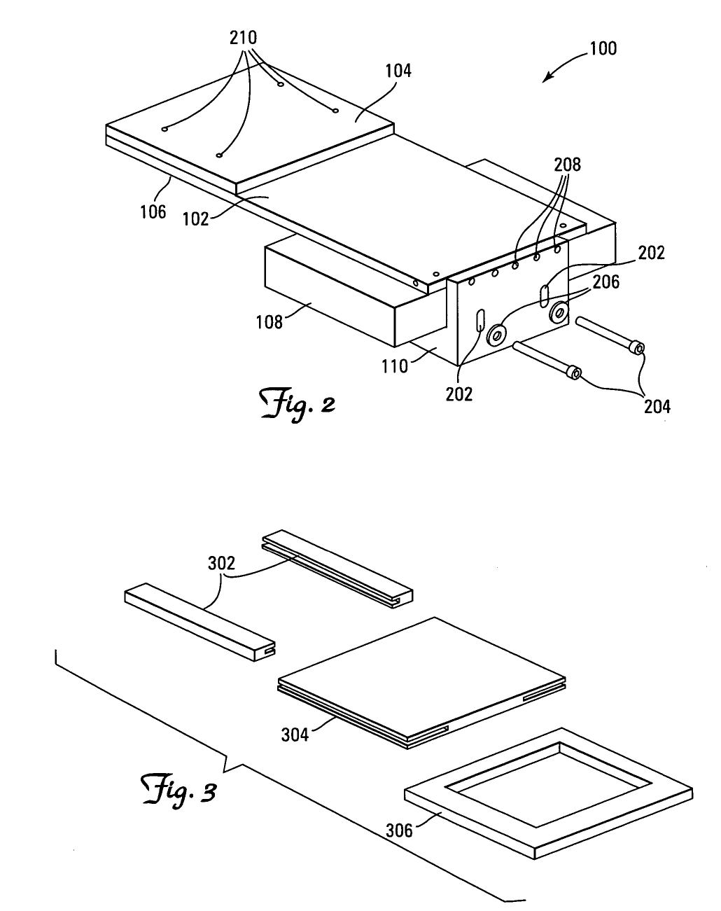

FIG. 2 is an isometric view of benchtop securing device 100 according to one embodiment of the present invention. FIG. 2 shows a top view of benchtop securing device 100. In the embodiment in FIG. 2, sloped member 110 is attached to mounting plate 102 using screws 208. In other embodiments, sloped member 108 and mounting plate form one continuous piece. In other embodiments, sloped member 108 is attached to mounting plate 102 using other means, such as glue. Additionally, various means are used to insert sliding block 114 (shown in FIG. 1) between sloped member 110 and table 108 such that sliding surface 116 (shown in FIG. 1) of sliding block 114 engages sloping surface 112 (shown in FIG. 1) of sloped member 110. For example, in the embodiment in FIG. 2, screws 204 and washers 206 are used. Screws 204 fit through washers 206 and slots 202 on sloped member 110. The length of screws 204 is sufficient to extend through slots 202 in sloped member 110 and connect to holes in sliding block 114. N number of screws 204 are used to insert sliding block 114 between sloped member 110 and table 108. In some embodiments, 2 screws are used. In other embodiments, other numbers of screws are used. As screws 204 are tightened, sliding surface 116 engages sloping surface 112 as sliding block 114 slides up sloping surface 112 of sloped member 110. Slots 202 are configured such that screws 204 are free to move vertically as screws 204 are tightened in sliding block 114 enabling sliding block 114 to be drawn further into the gap between table 108 and sloped member 110 causing sliding surface 116 to firmly engage sloping surface 112. The further sliding block 114 is drawn into the gap, the more firmly sliding surface 116 engages sloping surface 112. Hence, benchtop securing device 100 becomes more firmly secured. In other embodiments, other means for inserting sliding block 114 between sloped member 110 and table 108 such that sliding surface 116 firmly engages sloping surface 112 are used, such as clamps.

Additionally, shown in FIG. 2 is attaching surface 104 of mounting plate 102. Attaching surface 104 is used for securing objects to mounting plate 102. In the embodiment in FIG. 2, the mounting shape of attaching surface 104 is a raised flat plate with screw holes 210. In such embodiments, the object is secured to attaching surface 104 using screws which fit in screw holes 210. The raised portion is adapted to a given object which needs the lip created by the raised plate. In other embodiments, screws and screw holes are used without the raised lip. Although attaching surface 104 is displayed in FIG. 2 at one end of mounting plate 102, it will be understood by one of skill in the art that other sections of mounting plate 102 are used in other embodiments. Additionally, it will be understood by one of skill in the art that attaching surface 104 is not limited to the shape and size as displayed in FIG. 2, but can be of varying shapes and sizes in different embodiments. For example, FIG. 3 shows exemplary mounting shapes employed for attaching surface 104 in different embodiments.

FIG. 3 is an isometric view of exemplary mounting shapes 302-306 according to embodiments of the present invention. Attaching surface 104 of mounting plate 102 is adaptable to any shape suitable to secure a given object. This adaptability enables embodiments of the present invention to secure objects of varying sizes, shapes, and structural strength, etc. For example, in some embodiments, U-channels 302 are used by sliding an object into the U shape of U-channels 302. In other embodiments, I-beam 304 is similarly used where a portion of an object is slid into the openings of I-beam 304. In yet other embodiments, box 306 is used. In such embodiments, an object is placed into and secured within the walls of box 306. As will be understood by one of skill in the art, attaching surface 104 of mounting plate 102 can use any mounting shape suitable to secure a given object enabling embodiments of the present invention to be used with a large variety of objects. Additionally, it will be understood by one of skill in the art that, although exemplary mounting shapes 302, 304, and 306 are shown in FIG. 3, attaching surface 104 of mounting plate 102 is not limited to any particular mounting shape.

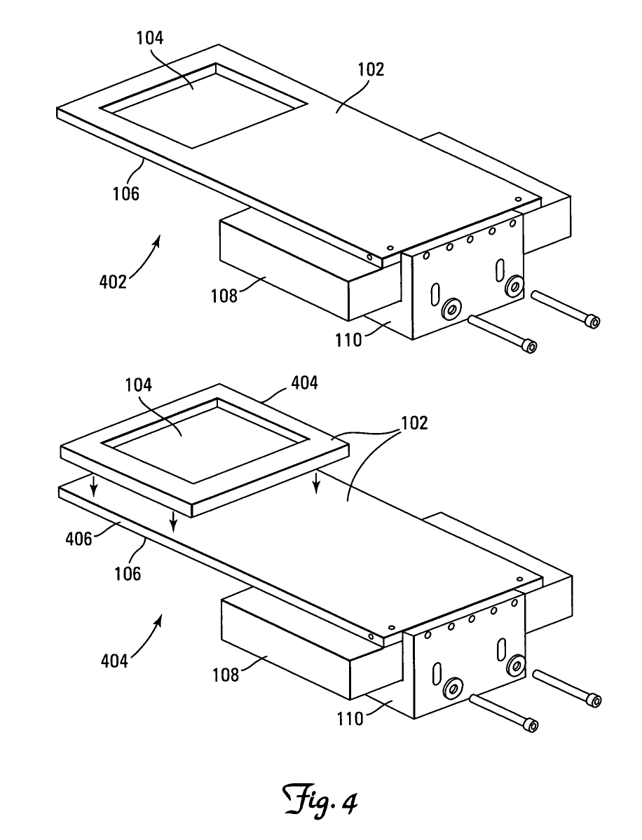

FIG. 4 is an isometric view of exemplary configurations 402 and 404 of mounting plate 102 according to embodiments of the present invention. Although only a box shape is shown in FIG. 4, it will be understood by one of skill in the art that other mounting shapes are used in attaching surface 104 in other embodiments. In some embodiments, as depicted by configuration 402, mounting plate 102 comprises one section with attaching surface 104 for mounting objects thereon and table engaging surface 106 for engaging table 108. In such embodiments, mounting shapes suitable for securing different objects, such as mounting shapes shown in FIG. 3, are formed in attaching surface 104 of mounting plate 102. In some such embodiments, mounting plate 102 is detachable from sloped member 110 enabling mounting plate 102 to be replaced by a second mounting plate with another attaching surface having a different mounting shape. This detachability is especially useful when the first object being secured is replaced by a second object which is better suited for a different mounting shape. The mounting shape of the second mounting plate depends on the characteristics of the second object. These characteristics include, among other things, the shape, size, location of load wires, and structural strength of the object. In this manner, objects of varying shape, size, strength, etc. can be secured without having to replace the entire benchtop device for each object to be secured.

In other embodiments, mounting plate 102 is comprised of at least two separable sections, attaching surface section 404 and one for table engaging surface section 406, as depicted in configuration 404. In such embodiments, mounting shapes, such as those shown in FIG. 3, are formed in attaching surface 104 of attaching surface section 104. Attaching surface section 404 is coupled to table engaging surface section 406. In some such embodiments, attaching surface section 404 is connected to table engaging surface section 40 using screws and screw holes. In other such embodiments, other means are used to connect attaching surface section 404 to table engaging surface section 406. In embodiments involving at least two separable sections, attaching surface section 404 is replaced by a second attaching surface section having an attaching surface with a different mounting shape when the object being secured is replaced by a second object whose characteristics require a different mounting shape.

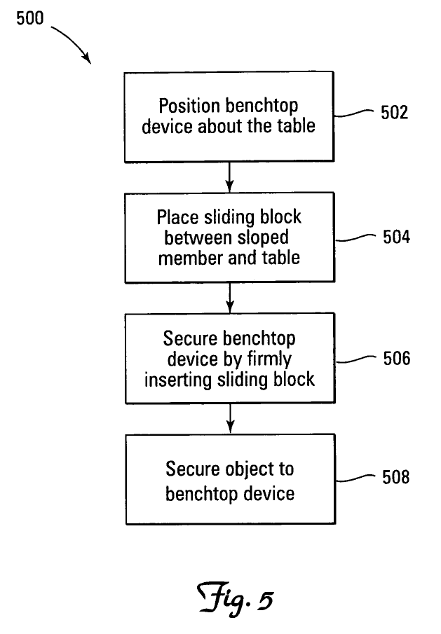

FIG. 5 is a flowchart showing a method 500 for securing an object to a table using a benchtop securing device according to one embodiment of the present invention. The benchtop securing device is comprised of a mounting plate, a sloped member and a sliding block. At 502, the benchtop device is positioned about a table edge such that the table is received between the mounting plate and the sloped member of the benchtop securing device leaving a gap between a sloping surface of the sloped member and a surface of the table. The mounting plate has an attaching surface adapted to mount an object thereon and a table engaging surface adapted to abut a surface of the table.

At 504, a sliding block is placed in the gap between the sloping surface of the sloped member and the table. The sliding block has a sliding surface which has a slope that substantially matches slope of the sloping surface of the sloped member. As the sliding block is inserted in the gap between the sloping surface of the sloped member and the table, the sliding surface of the sliding block engages the sloping surface of the sloped member. When the sliding surface of the sliding block engages the sloping surface, the benchtop securing device becomes secured to the table. At 506, the sliding block is firmly inserted between the sloped member and the table, firmly securing the benchtop device to the table. Various means are used in different embodiments for firmly inserting the sliding block. In one embodiment, screws are inserted through slots in the sloped member and connected to screw holes in the sliding block. As the screws are tightened, the sliding block moves further into the gap causing the sliding surface of the sliding block to firmly engage the sloping surface of the sloped member. In other embodiments, firmly inserting the sliding block is accomplished by using clamps. In other embodiments, other means are used to firmly insert the sliding block in the gap to cause the sliding surface to firmly engage the sloping surface of the sloped member which secures the benchtop securing device to the table.

At 508, an object is secured to an attaching surface of the mounting plate of the benchtop securing device. Various means are used for securing an object to the attaching surface of the mounting plate. For example, in some embodiments, screws and screw holes are used. In other embodiments, the attaching surface has one of a plurality of mounting shapes, such as those described above with regards to FIG. 3. The mounting shape of the attaching surface helps secure an object, in addition to other means used. In some embodiments, the mounting plate is detachable from the sloping member, enabling the mounting plate to be replaced by a second mounting plate with an attaching surface having a different mounting shape. In some embodiments, the mounting plate is comprised of at least two separable sections; an attaching surface section with the attaching surface and a table engaging surface section having the table engaging surface. The attaching surface section is coupled to the table engaging surface section. In some such embodiments, the attaching surface section is detachable from the table engaging surface section, enabling the attaching surface section to be detached and replaced by another attaching surface section having an attaching surface with a different mounting shape. Various means known to one of skill in the art are used for coupling the attaching surface section to the table engaging surface section. For example, in some embodiments, the attaching surface section is coupled to the table engaging surface section using glue. In other embodiments, screws and screw holes are used. In other embodiments, other means are used for coupling the attaching surface section to the table engaging surface section. By allowing the removal and replacement of the separable attaching surface, in some embodiments, and the mounting plate, in other embodiments, embodiments of the present invention extend the utility of the benchtop securing device by enabling the benchtop securing device to receive and secure objects of varying size, shape, structural strength, etc.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A benchtop securing device for securing objects to a table comprising:
a mounting plate having a table engaging surface adapted to abut a surface of a table, the mounting plate further having an object attaching surface adapted to mount an object thereon;
a sloped member having a sloping surface, the sloped member further being coupled to the mounting plate such that the table can be received between the mounting plate and the sloping surface of the sloped member; and
a sliding block having a sliding surface that has a slope that substantially matches the slope of the sloping surface of the sloped member, wherein when the sliding surface of the sliding block engages the sloping surface of the sloped member the benchtop securing device becomes securely attached to the table.

2. The benchtop securing device of claim 1, wherein the attaching surface of the mounting plate is one of a flat plate, a pair of U-channels, an I-beam, and a box.

3. The benchtop securing device of claim 1, wherein the mounting plate further comprises:
an attaching surface section including the attaching; and
a table engaging surface section including the table engaging surface.

4. The benchtop securing device of claim 3, wherein the table engaging surface section is adapted to receive one or more of a plurality of attaching surface sections each of the plurality of attaching surface section having an attaching surface with different mounting shapes.

5. The benchtop securing device of claim 1, further comprising:
one or more screws for attaching the sliding block to the sloped member through slots in the sloped member, wherein the sliding block is inserted further into the gap as the one or more screws are tightened.

6. The benchtop securing device of claim 5, wherein slots in the sloped member are configured so as to allow vertical movement of the one or more screws as the screws are tightened in the sliding block.

7. A benchtop securing device for securing objects to a table comprising:
means for securing an object to a mounting plate;
means for coupling the mounting plate to a sloped member; and
means for engaging the sloped member with a sliding block to secure the mounting plate to a table.

8. A method for securing an object to a table using a benchtop securing device, the method comprising:
positioning a benchtop securing device about a table such that the table is received between a mounting plate and a sloped member of the benchtop securing device leaving a gap between a sloping surface of the sloped member and a surface of the table;
inserting a sliding block having a sliding surface with a slope that substantially matches the slope of the sloping surface of the sloped member between the sloping surface of the sloped member and the surface of the table such that the sliding surface of the sliding block engages the sloping surface of the sloped member, wherein when the sliding surface of the sliding block engages the sloping surface of the sloped member the benchtop securing device becomes securely attached to the table; and
coupling an object to the mounting plate of the benchtop securing device.

9. The method of claim 8, wherein inserting a sliding block further comprises:
connecting the sliding block to one or more screws through one or more slots in the sloped member; and
tightening the one or more screws until the sliding surface of the sliding block firmly engages the sloping surface of the sloped member.

10. The method of claim 8, wherein coupling an object to a mounting plate further comprises:
configuring the mounting shape of an attaching surface of the mounting plate based on characteristics of the object to be coupled; and
coupling the object to the attaching surface of the mounting plate.

11. The method of claim 10, further comprising:
replacing the attaching surface with a second attaching surface having a different mounting shape configured based on characteristics of a second object; and
attaching the second object to the second attaching surface.

12. The method of claim 11, wherein replacing the attaching surface with a second attaching surface further comprises:
decoupling the mounting plate from the sloped member; and
coupling a second mounting plate with the second attaching surface to the sloped member.

13. The method of claim 11, wherein replacing the attaching surface with a second attaching surface further comprises:
decoupling the attaching surface from a table engaging surface of the mounting plate; and
coupling the second attaching surface to the table engaging surface of the mounting plate.
